(19) United States
(12) Patent Application Publication
(10) Pub. No.: US 2025/0190638 A1
(43) Pub. Date: Jun. 12, 2025

(54) GLASS DRAINAGE PLATES MANUFACTURED BASED ON GLASS SUBSTRATES USING OVERFLOW PROCESSES AND DESIGN SYSTEMS THEREOF

(71) Applicant: CAIHONG DISPLAY DEVICES CO., LTD., Xianyang (CN)

(72) Inventors: Menghu LI, Xianyang (CN); Jian XU, Xianyang (CN); Weidong HU, Xianyang (CN)

(73) Assignee: CAIHONG DISPLAY DEVICES CO., LTD., Xianyang (CN)

(21) Appl. No.: 18/970,844

(22) Filed: Dec. 5, 2024

Related U.S. Application Data
(63) Continuation-in-part of application No. PCT/CN2024/092918, filed on May 13, 2024.

(30) Foreign Application Priority Data
Dec. 6, 2023 (CN) 202311670693.0

(51) Int. Cl. G06F 30/10; C03B 17/06; G06F 30/28; G06F 113/08; G06F 113/24; G06F 119/18

(52) U.S. Cl. CPC G06F 30/10; C03B 17/064; G06F 30/28; G06F 2113/08; G06F 2113/24; G06F 2119/18

(57) ABSTRACT

Disclosed is a glass drainage plate manufactured based on a glass substrate using an overflow process and a design system. The design system selects a drainage plate of a mature overflow system as a reference drainage plate, obtains a geometric structure parameter, a width of an overflow surface, an upper-and-lower contraction width, and a slope height of an overflow brick of a reference drainage plate, an overflow coefficient of the mature overflow system, and a flow contraction ratio of a side plate without the drainage plate, establishes a geometric structure similarity, a drainage plate width similarity, a critical contraction width similarity, a critical side plate flow similarity, a drainage side plate thickness similarity relationship, and an average side plate width similarity relationship, determines a structure size of a to-be-designed drainage plate based on the relationships to complete design of a structure of the drainage plate of a new overflow system.

### CROSS REFERENCE TO RELATED APPLICATIONS

This application is a Continuation-in-part of International Application No. PCT/CN2024/092918, filed on May 13, 2024, which claims priority to Chinese application No. 202311670693.0, filed on Dec. 6, 2023, the entire contents of which are incorporated herein by reference.

### TECHNICAL FIELD

The present disclosure generally relates to the field of glass substrate manufacturing, and in particular, to a glass drainage plate manufactured based on a glass substrate using an overflow process and a design system.

### BACKGROUND

There are three main manufacturing processes for glass substrates: the float process, the down-draw process, and the overflow fusion process, with the overflow fusion process being the current mainstream process. This process involves introducing molten glass into a trough, and once the glass reaches its maximum capacity, it overflows downwards along the walls on both sides of the trough, resembling a waterfall. The glass then converges below to form a sheet-like substrate. The overflow fusion process can produce ultra-thin glass substrates with dual pristine glass surfaces. Compared to the float process and the down-draw process, the overflow fusion process eliminates the need for subsequent processing like grinding or polishing. It has now become the leading manufacturing process for glass substrates used in the production of flat panel displays, such as TFT-LCD (Thin Film Transistor Liquid Crystal Display) and PDP (Plasma Display Panel).

Glass overflow and draw-down processes involve complex structural changes (both in physical dimensions and at the molecular level). By establishing relevant dynamic models, a thickness distribution and stress law of an overflow surface and below the root may be revealed. This allows to analyze the causes of overflow brick wetting and determine the size and material of proximal baffles, thereby supporting the design of wetting process technologies and preventing clogging. All of these factors are related to the drainage plates at the distal and proximal ends of the overflow system and the stabilization of the drainage flow.

The design and optimization of the fluid dynamics for a forming side plate involve considering the overflow system's design, adjusting the height of the edge puller, optimizing the structure of the drainage plate, and enhancing the process environment. By conducting simulations or analyses, how factors like the structure of the drainage plate and the viscosity-temperature relationship affect the glass flow pattern can be studied. This understanding allows for the optimization of the side plate thickness, improvement of the side plate's flow pattern, enhancement of drainage stability, and expansion of process margins. Poor coordination of the overflow brick's tip viscosity, surface tension in the thickness-forming zone, vertical positioning of the edge puller, and the cooling and traction of the edge puller wheels can all lead to local thinning or pitting in the transition zone between the side plate and the effective surface, which affects forming stability and increases the risk of plate breakage. The edge puller generates an outward equivalent tensile force in the transition zone, while surface tension creates an inward contraction force. As the height of the edge puller decreases, the width of the drainage plate also decreases, and concurrently, the viscosity and viscous resistance relatively increase, which weakens the pulling force and results in a trend of increasing thickness in the transition zone.

In recent years, to improve production line efficiency, the size of glass substrates has been increasing, and the demand for higher output quality has risen. In existing technology, the stability of glass drainage plates is poor and cannot meet the demands of new generations and higher output quality. Initially, the side plate and flow pattern issues appear to have a considerable margin for adjustment. However, as mass production continues, the flow pattern of the side plate begins to deteriorate, resulting in diminished stability, mainly exhibited through issues such as hollow cores, misalignment, size inconsistency, and thinning. The structure size of the drainage plate tip affects the width of the substrate, the thickness of the side plate, and the stability of the flow pattern. The optimal structure of the drainage plate adheres to the principle of similarity. Ideally, the glass flows just from the plate tip of the drainage plate, ensuring the most stable flow pattern, which is considered the standard design for drainage plates.

Therefore, it is necessary to provide a glass drainage plate manufactured based on the glass substrate using an overflow process and a design system, to provide technical support for the optimization of the design of the structure of the drainage plate and improvement of the flow pattern of the side plate.

### SUMMARY

In order to solve a problem in the prior art, the embodiments of the present disclosure provide a glass drainage plate manufactured based on a glass substrate using an overflow process and a design system. Through analytical calculations, the design system investigates the influence laws of structural changes of the drainage plate on a drainage plate width, a thickness of a side plate, and a flow pattern stability, establishes relevant numerical relationships and distribution laws, and provides more scientific design criteria and evaluation criteria for the design of the drainage plate with a large lead-out quality. The design system may also meet technical requirements of high efficiency, targeting, digitalization, and parameterization, thereby ensuring that the designed glass drainage plates satisfy the needs of higher generations and greater lead-out quality.

One or more embodiments of the present disclosure provide a design system for a glass drainage plate manufactured based on a glass substrate using an overflow process, comprising an obtaining module, a geometric structure similarity module, a drainage plate width similarity module, a critical contraction width similarity module, a critical side plate flow similarity module, a design module, a storage module, and an interaction module; wherein the obtaining module is configured to: select a drainage plate of a mature overflow system as a reference drainage plate, and obtain a geometric structure parameter, a width of an overflow surface, an upper-and-lower contraction width, and a slope height of an overflow brick of the reference drainage plate, an overflow coefficient of the mature overflow system, and a flow contraction ratio of a side plate without the drainage plate; the geometric structure similarity module is configured to: establish, based on the slope height of the overflow brick of the reference drainage plate, a geometric structure similarity relationship between the reference drainage plate and a to-be-designed drainage plate; the drainage plate width similarity module is configured to: establish, based on the geometric structure parameter of the reference drainage plate, the width of the overflow surface, and the overflow coefficient, a drainage plate width similarity relationship between the reference drainage plate and the to-be-designed drainage plate; the critical contraction width similarity module is configured to: establish, based on the geometric structure parameter of the reference drainage plate, and the width of the overflow surface, a critical contraction width similarity relationship between the reference drainage plate and the to-be-designed drainage plate; the critical side plate flow similarity module is configured to: establish, based on the geometric structure parameter of the reference drainage plate, a design lead-out quality, and a flow contraction coefficient, a critical side plate flow similarity relationship between the reference drainage plate and the to-be-designed drainage plate; the design module is configured to: establish, based on the reference drainage plate, a standard width of a glass substrate, a standard thickness of the glass substrate, the geometric structure similarity relationship, the drainage plate width similarity relationship, the critical contraction width similarity relationship, and the critical side plate flow similarity relationship, a drainage side plate thickness similarity relationship and an average side plate width similarity relationship between the reference drainage plate and the to-be-designed drainage plate to complete a design of a structure of the drainage plate of the mature overflow system, and store the plurality of similarity relationships into the storage module; and the design module is further configured to: obtain a to-be-implemented sizing parameter of the to-be-designed drainage plate and an overflow parameter, and obtain the plurality of similarity relationships from the storage module; determine, based on the to-be-implemented sizing parameter and the plurality of similarity relationships, a design compliance rate for the to-be-implemented sizing parameter; in response to a determination that the design compliance rate is smaller than a first preset threshold: run a simulation instruction which is stored in the storage module, the simulation instruction being configured to perform a plurality of iterations, each iteration including at least one simulation, and obtain an average stability of a drainage pattern based on results of a plurality of simulations; wherein each iteration includes: establishing a simulation model of a to-be-designed overflow system based on the to-be-implemented sizing parameter, wherein the to-be-designed overflow system includes an overflow brick, an overflow groove, a glass liquid feeding device, and a drainage plate; and performing a simulation on the to-be-designed overflow system for manufacturing glass by the overflow process based on the simulation model, and determining a stability of the drainage pattern for the iteration; and in response to a determination that the average stability of the drainage pattern is smaller than a second preset threshold: generate a recommended optimization parameter and generate a reminder message based on the recommended optimization parameter, and send the reminder message to the interaction module.

One or more embodiments of the present disclosure provide a glass drainage plate manufactured based on a glass substrate using an overflow process, wherein the glass drainage plate is manufactured based on the design system for the glass drainage plate manufactured based on a glass substrate using an overflow process.

Beneficial effects of the above invention include, but are not limited to, the following: based on the similarity of the drainage plate of the reference overflow system and the geometric structure, the drainage plate width, the critical contraction width, and the critical side plate flow, the design system establishes a design basis of a structure of a drainage plate of a new overflow system with increased lead-out quality, while taking into account the drainage side plate thickness and the average side plate width of the drainage plate, which can satisfy the needs of higher generations and greater lead-out quality.

### BRIEF DESCRIPTION OF THE DRAWINGS

FIG. 1 is a schematic diagram illustrating an application scenario of a design system for a glass drainage plate manufactured based on a glass substrate using an overflow process according to some embodiments of the present disclosure;

FIG. 2 is a block diagram illustrating a design system for a glass drainage plate manufactured based on a glass substrate using an overflow process according to some embodiments of the present disclosure;

FIG. 3 is a schematic diagram illustrating a front view of a kiln structure and electrode configuration according to some embodiments of the present disclosure;

FIG. 4 is a schematic diagram illustrating a partial structure of overflow pull-down according to some embodiments of the present disclosure;

FIG. 5 is a schematic diagram illustrating a structure of a drainage plate according to some embodiments of the present disclosure;

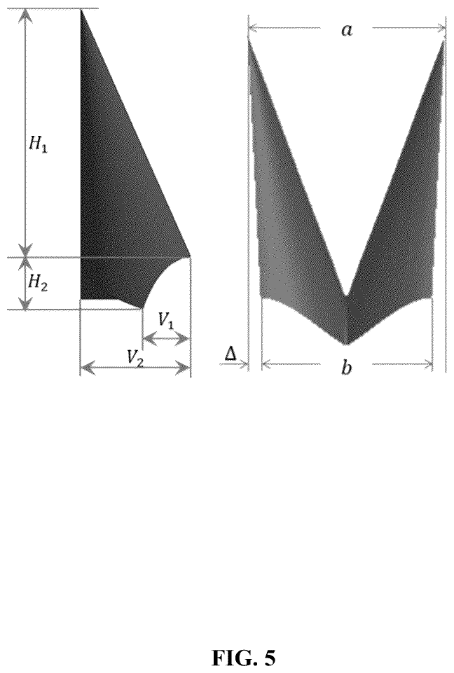

FIG. 6 is a schematic diagram illustrating a change relationship between a width V₂ of a drainage plate and a flow pattern of a side plate according to some embodiments of the present disclosure;

FIG. 7 is a schematic diagram illustrating a change trend of a width V₂ of a drainage plate, an average side plate thickness, and a drainage plate width according to some embodiments of the present disclosure;

FIG. 8 is a schematic diagram illustrating a change relationship between a height H₂ and a width V₁ of a drainage plate and a flow pattern of a side plate according to some embodiments of the present disclosure;

FIG. 9 is a schematic diagram illustrating a change trend of a height H₂ and a width V₁ of a drainage plate, an average side plate thickness, and a drainage plate width according to some embodiments of the present disclosure;

FIG. 10 is a schematic diagram illustrating changes in glass drainage pattern through comprehensive optimization of a structure of a drainage plate according to some embodiments of the present disclosure;

FIG. 11 is an exemplary flowchart illustrating a process for manufacturing a glass drainage plate based on a design system for the glass drainage plate manufactured based on a glass substrates using an overflow process according to some embodiments of the present disclosure;

FIG. 12 is an exemplary tabular schematic diagram illustrating a structure and related parameters of a drainage plate of a reference overflow system and a drainage plate of a to-be-designed overflow system according to some embodiments of the present disclosure; and

FIG. 13 is an exemplary flowchart illustrating a process for optimizing parameters of a to-be-designed drainage plate according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios according to the accompanying drawings without creative labor. Unless obviously obtained from the context or the context illustrates otherwise, the same numeral in the drawings refers to the same structure or operation.

As used herein, “system”, “device”, “unit” and/or “module” are used as a means of distinguishing between different components, elements, parts, sections, or assemblies at different levels. However, the words may be replaced by other expressions if other words would accomplish the same purpose.

Unless the context clearly suggests an exception, the words “a”, “an”, “one”, and/or “the” do not refer specifically to the singular, but may also include the plural. Generally, the terms “including” and “comprising” only suggest the inclusion of explicitly identified steps and elements that do not constitute an exclusive list, and the method or device may also include other steps or elements.

In recent years, sizes of glass substrates have become larger and lead-out quality have increased to improve line efficiency. In order to meet needs of higher generation and greater lead-out quality, especially a requirement of guaranteeing the stability of a glass drainage plate, a structure optimization of an overflow system and a drainage plate is one of the core of the design.

Some embodiments of the present disclosure provide a glass drainage plate manufactured based on a glass substrate using an overflow process and a design system. The design system selects a drainage plate of a mature overflow system as a design reference, obtains parameters such as a geometric structure parameter, a width of an overflow surface, an upper-and-lower contraction width, and a slope height of an overflow brick of a reference drainage plate, an overflow coefficient of the mature overflow system, and a flow contraction ratio of a side plate without the drainage plate, respectively, establishes relationships such as a geometric structure similarity relationship, a drainage plate width similarity relationship, a critical contraction width similarity relationship, and a critical side plate flow similarity relationship, respectively, and establishes a drainage side plate thickness similarity relationship and an average side plate width similarity relationship, and determines a structure size of a to-be-designed drainage plate, for example, a first height, a second height, a first width, a second width, an upper-and-lower contraction width of the to-be-designed drainage plate, or the like, to complete design of a structure of the drainage plate of a new overflow system.

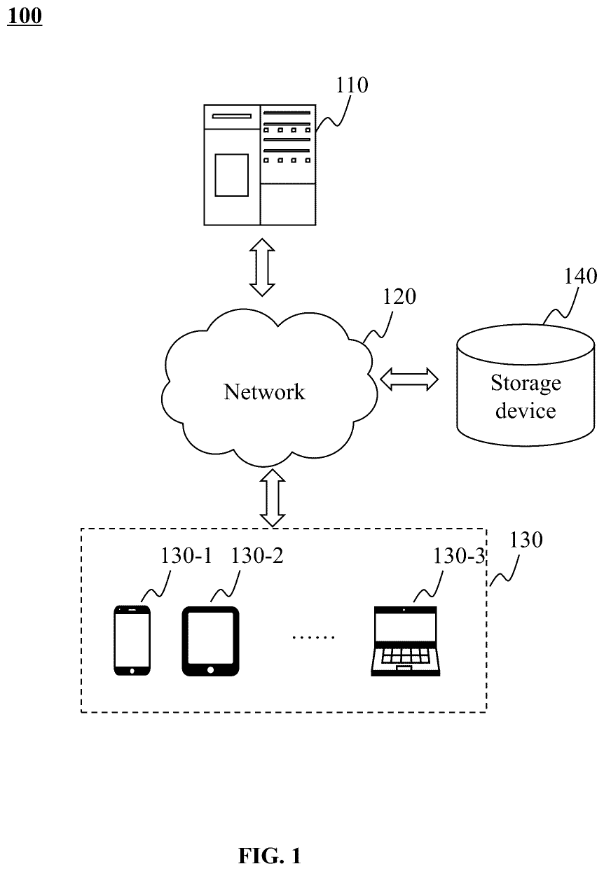

FIG. 1 is a schematic diagram illustrating an application scenario of a design system for a glass drainage plate manufactured based on a glass substrate using an overflow process according to some embodiments of the present disclosure.

As shown in FIG. 1, an application scenario 100 covered by the embodiments of the present disclosure may include a processor 110, a network 120, a user terminal 130, a storage device 140, and a data acquisition device 150.

In some embodiments, the design system for the glass drainage plate may implement a design process of the glass drainage plate manufactured based on the glass substrate using the overflow process disclosed in the present disclosure.

The processor 110 may process data and/or information obtained from other devices or system components. The processor 110 may execute program instructions based on such data, information, and/or processing results to perform one or more of functions described in the present disclosure. In some embodiments, the processor 110 may include one or more sub-processing devices, for example, a single-core processing device or a multi-core multi-chip processing device. Merely by way of example, the processor 110 may include a central processing unit (CPU), an application-specific integrated circuit (ASIC), an application-specific instruction processor (ASIP), a graphics processor (GPU), a physical processor (PPU), a digital signal processor (DSP), a field-programmable gate array (FPGA), a programmable logic circuit (PLD), a controller, a microcontroller unit, a reduced instruction set computer (RISC), microprocessor, etc., or any combination of the above.

The network 120 may provide a channel for information exchange. In some embodiments, information may be exchanged between the processor 110, the user terminal 130, and the storage device 140 via the network 120. For example, the processor 110 may receive, via the network 120, information about data related to a to-be-designed drainage plate sent by the user terminal 130. As another example, the processor 110 may read data stored by the storage device 140 via the network 120.

The user terminal 130 refers to one or more terminal devices or software used by a user. In some embodiments, the user terminal 130 may be one of a mobile device 130-1, a tablet computer 130-2, a laptop computer 130-3, and other devices that have input and/or output functions or any combination thereof. In some embodiments, the user terminal 130 may serve as a display terminal of a data-sending party for obtaining and displaying data and/or information, operating status, etc., collected by the data acquisition device 150 via the network 120. In some embodiments, the user terminal 130 may act as a data-receiving device and a display terminal of a data-receiving party for receiving and displaying received data and/or information. The above examples are intended only to illustrate the breadth of a device range of the user terminal 130 and are not intended to be a limitation of the device range.

The storage device 140 may be configured to store data and/or instructions. The storage device 140 may obtain data and/or instructions from the processor 110, the data acquisition device 150, the user terminal 130, or the like. In some embodiments, the storage device 140 may store data and/or instructions used by the processor 110 to execute or use to accomplish the exemplary processes described in the present disclosure.

The data acquisition device 150 may be configured to acquire data and/or information, operating status, etc., related to the glass drainage plate.

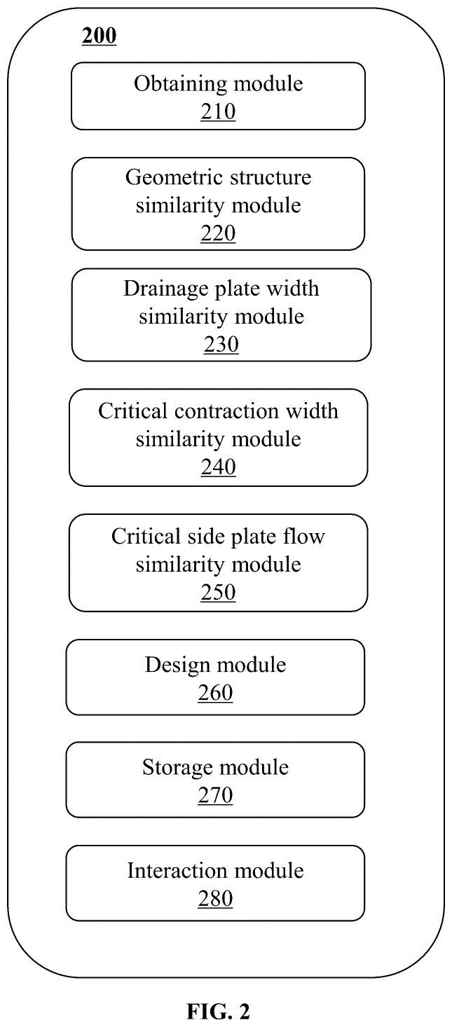

FIG. 2 is a block diagram illustrating a design system for a glass drainage plate manufactured based on a glass substrate using an overflow process according to some embodiments of the present disclosure. As shown in FIG. 2, a design system 200 for a glass drainage plate includes an obtaining module 210, a geometric structure similarity module 220, a drainage plate width similarity module 230, a critical contraction width similarity module 240, a critical side plate flow similarity module 250, a design module 260, a storage module 270, and an interaction module 280.

In some embodiments, the obtaining module 210 is configured to: select a drainage plate of a mature overflow system as a reference drainage plate, and obtain a geometric structure parameter, a width of an overflow surface, an upper-and-lower contraction width, and a slope height of an overflow brick of the reference drainage plate, an overflow coefficient of the mature overflow system, and a flow contraction ratio of a side plate without the drainage plate.

In some embodiments, the geometric structure similarity module 220 is configured to: establish, based on the slope height of the overflow brick of the reference drainage plate, a geometric structure similarity relationship between the reference drainage plate and a to-be-designed drainage plate.

In some embodiments, the drainage plate width similarity module 230 is configured to: establish, based on the geometric structure parameter of the reference drainage plate, the width of the overflow surface, and the overflow coefficient, a drainage plate width similarity relationship between the reference drainage plate and the to-be-designed drainage plate.

In some embodiments, the critical contraction width similarity module 240 is configured to: establish, based on the geometric structure parameter of the reference drainage plate, and the width of the overflow surface, a critical contraction width similarity relationship between the reference drainage plate and the to-be-designed drainage plate.

In some embodiments, the critical side plate flow similarity module 250 is configured to: establish, based on the geometric structure parameter of the reference drainage plate, a design lead-out quality, and a flow contraction coefficient, a critical side plate flow similarity relationship between the reference drainage plate and the to-be-designed drainage plate.

In some embodiments, the design module 260 is configured to: establish, based on the reference drainage plate, a standard width of a glass substrate, a standard thickness of the glass substrate, the geometric structure similarity relationship, the drainage plate width similarity relationship, the critical contraction width similarity relationship, and the critical side plate flow similarity relationship, a drainage side plate thickness similarity relationship and an average side plate width similarity relationship between the reference drainage plate and the to-be-designed drainage plate to complete design of a structure of the drainage plate of the mature overflow system, and store the plurality of similarity relationships into the storage module 270.

In some embodiments, the design module 260 is further configured to: obtain a to-be-implemented sizing parameter of the to-be-designed drainage plate and an overflow parameter, and obtain the plurality of similarity relationships from the storage module 270; determine, based on the to-be-implemented sizing parameter and the plurality of similarity relationships, a design compliance rate for the to-be-implemented sizing parameter; in response to a determination that the design compliance rate is smaller than a first preset threshold: run a simulation instruction which is stored in the storage module 270, the simulation instruction being configured to perform a plurality of iterations, each iteration including at least one simulation, and obtain an average stability of a drainage pattern based on results of a plurality of simulations.

In some embodiments, each iteration includes: establishing a simulation model of the to-be-designed overflow system based on the to-be-implemented sizing parameter, wherein the to-be-designed overflow system includes an overflow brick, an overflow groove, a glass liquid feeding device, and a drainage plate; and performing a simulation on the to-be-designed overflow system for manufacturing glass by the overflow process based on the simulation model, and determining a stability of the drainage pattern for the iteration. In some embodiments, in response to a determination that the average stability of the drainage pattern is smaller than a second preset threshold, the design module 260 is further configured to generate a recommended optimization parameter and generate a reminder message based on the recommended optimization parameter, and send the reminder message to the interaction module 280.

It is to be noted that the above description of the design system for the glass drainage plate manufactured based on the glass substrate using the overflow process and its modules is provided only for descriptive convenience, and it does not limit the present disclosure to the scope of the embodiments cited. It is to be understood that for a person skilled in the art, after understanding the principle of the design system, it is possible to arbitrarily combine individual modules or form a subsystem to connect with other modules without departing from this principle. In some embodiments, the obtaining module 210, the geometric structure similarity module 220, the drainage plate width similarity module 230, the critical contraction width similarity module 240, the critical side plate flow similarity module 250, the design module 260, the storage module 270, and the interaction module 280 disclosed in FIG. 2 may be different modules in a single system, or a single module that implements the functions of two or more of the aforementioned modules. For example, the individual modules may share a storage module, and the individual modules may each have an own storage module. Morphisms such as these are within the scope of protection of the present disclosure.

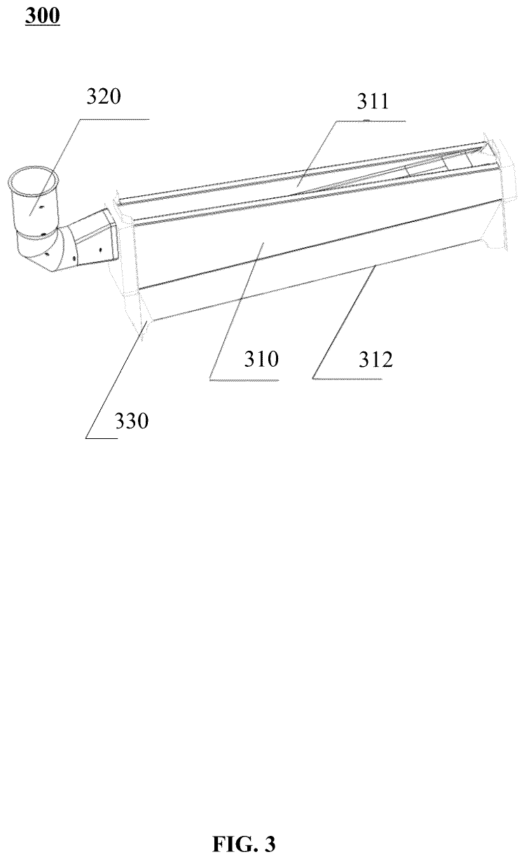

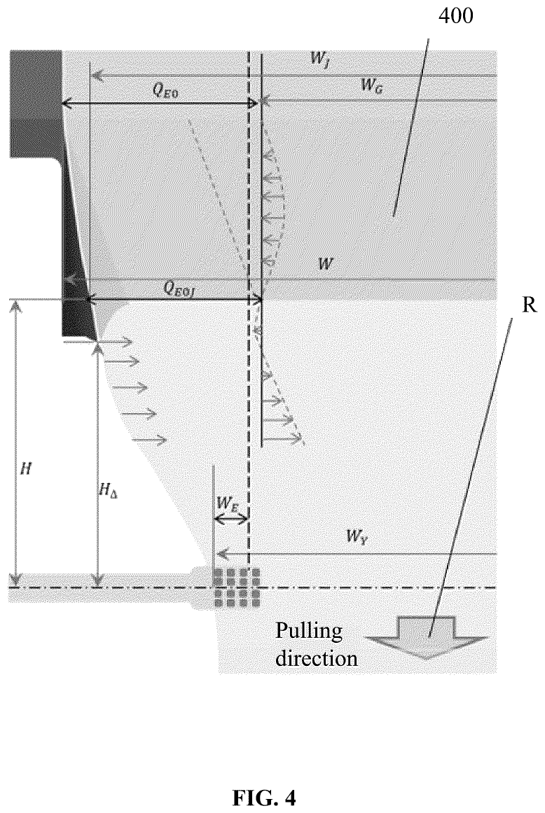

FIG. 3 is a schematic diagram illustrating a front view of a kiln structure and electrode configuration according to some embodiments of the present disclosure; and FIG. 4 is a schematic diagram illustrating a partial structure of overflow pull-down according to some embodiments of the present disclosure.

As shown in FIG. 3, an overflow system 300 includes an overflow brick 310 and a glass liquid feeding device 320 connected with the overflow brick 310; an overflow groove 311 is provided in the overflow brick 310, and a bottom of the overflow brick 310 is a root 312 of the overflow brick 310. When manufacturing a glass substrate using an overflow fusion manner, during a forming process, a molten glass liquid is provided by a glass melting furnace to the glass liquid feeding device 320 in an overflow fusion forming device, and overflows along both sides of the overflow brick 310 through the overflow groove 311, then the glass substrate is formed below the root 312 of the overflow brick 310.

As the molten glass liquid advances from a proximal end of the overflow groove 311 (i.e., an end near the glass liquid feeding device 320) to a distal end (i.e., an end away from the glass liquid feeding device 320), the molten glass liquid is driven by a gravitational force and a pressure in a flow direction to overcome the laminar viscous resistance, and flows downward from an overflow weir. The hydrodynamic equations based on this principle integrate the effects of the aforementioned forces and serve as a foundation for a design of the overflow groove. In a vertical plane of the overflow, the gravitational force and pressure are sufficiently large, and the viscosity is relatively low, resulting in minimal impact from lateral surface tension and almost no lateral contraction. On an inclined plane, the components of gravitational force and pressure along the inclined plane decrease significantly, and the viscosity gradually increases, making the effect of lateral surface tension more pronounced, leading to noticeable lateral contraction. Therefore, a drainage plate 330 is installed at both the proximal and distal ends of the inclined plane of the overflow brick to partially counteract the lateral contraction of the glass.

The drainage plate 330 may be made of platinum. The glass liquid is almost completely infiltrated with platinum (in an air environment). A wetted surface of the drainage plate 330 provides a horizontal wetted length greater than an intercepted length of the overflow surface, when unfolding or spreading out the glass that flows thereon, a thickness of a longitudinal edge is reduced actually. The drainage plate 330 counteracts the effects of surface tension and volume forces on the width of the glass band to widen the glass band. Optimization of a shape of the drainage plate 330 may have an improvement on plate width contraction and dispensing stability, but it may not affect the dispensing (a flow amount) at the distal and proximal ends of the glass band too much.

Side plate dispensing and balancing: the glass liquid starts to be distributed from the overflow weir, with no glass contraction occurring in the vertical plane of the overflow surface. The balance of the dispensing depends on (1) a bottom curve of the groove; (2) coordination of a flow amount, a viscosity, and a tilt angle of a muffle furnace; (3) stability of the flow amount and a viscous temperature; (4) gradual creep of the overflow brick over time. Glass contraction and aggregation: the glass liquid starts contracting from the inclined plane, and due to a wetting and widening effect of the drainage plate 330, the contraction reduces to zero once a certain width is achieved, and a certain amount of the glass material aggregates on the drainage plate 330, at this time, the dispensing of the side plate is comparable to that of the overflow weir. If the width is a virtual drawn edge with at this point, the plate velocity is minimized. Dispensing evolution and plate speed: as an edge puller moves downward, the plate width decreases, causing the glass material to flow from the side plate towards the center, and the side plate flow is decreased. At this point, the dispensing of the side plate is less than an initial dispensing of the overflow weir.

The temperatures of a platinum baffle and the drainage plate 330 are crucial for crystallization of the drainage plate, drainage stability, and a condition of the side plate. The platinum baffle and the drainage plate 330 have a very strong heat dissipation capability, so that temperatures at the proximal and distal ends are much lower than at the center. Since a size of the proximal baffle is much larger than a size of the distal baffle, and the glass at the proximal end travels a longer distance downward than the distal end, the temperature of the proximal baffle is significantly lower than the temperature of the distal baffle. Theoretically, the baffle has the smallest heat dissipation area when the baffle is flat, and complex flanging increases the strength but also increases the heat dissipation area.

Regarding the side plate and issues of the flow pattern stability, there appears to be a considerable margin from a perspective of an initial drainage plate. However, as mass production continues, the flow pattern of the side plate begins to deteriorate, leading to reduced stability, which is mainly manifested in process issues such as hollow cores, misalignment, variable sizes, and thinning. A structure size of a tip of the drainage plate affects the drainage plate width, the side plate thickness, and the flow pattern stability. An optimal structure of the drainage plate satisfies a similarity principle. When the glass liquid just flows out from the plate tip of the drainage plate, the flow pattern is most stable, which is a standard design of the drainage plate. Through analytical calculations, the influence laws of structural changes of the drainage plate on the drainage plate width, the thickness of the side plate, and the flow pattern stability are investigated, relevant numerical relationships and distribution laws are established, which help to provide technical support for the optimization of the design of the structure of the drainage plate and improvement of the flow pattern of the side plate.

As shown in FIG. 4, the drainage plate 330 serves as a forming foundation for a glass substrate 400. During a downward forming process of the glass substrate 400, the molten glass liquid gradually forms the glass substrate 400 along the drainage plate 330, with the formed glass substrate 400 moving downward in a pulling direction R.

As shown in FIG. 4, W_{G} is a standard width of the glass substrate, W_{Y} is a width of the drainage plate, W is a width of an overflow surface of the overflow brick, W_{J} is a critical contraction width of the drainage plate, Q_{E0} is an uncontracted average side plate flow quality, Q_{E0J} is a critical side plate flow quality of the drainage plate, and W_{E} is an average side plate width.

In a width direction, the center of the glass substrate 400 has a thin and uniform thickness, and the thickness from the center to sides of the glass substrate 400 is increasingly thicker. W_{G} is a target standard width of the glass substrate (i.e., an effective surface width of the glass substrate), which is generally a middle portion with the uniform thickness.

In some embodiments, a side plate thickness that needs to be removed is determined by subtracting the standard width W_{G} of the glass substrate from the drainage plate width W_{Y} of the drainage plate. This embodiment controls the stability of the side plate drainage and the side plate thickness through the structure design of the drainage plate.

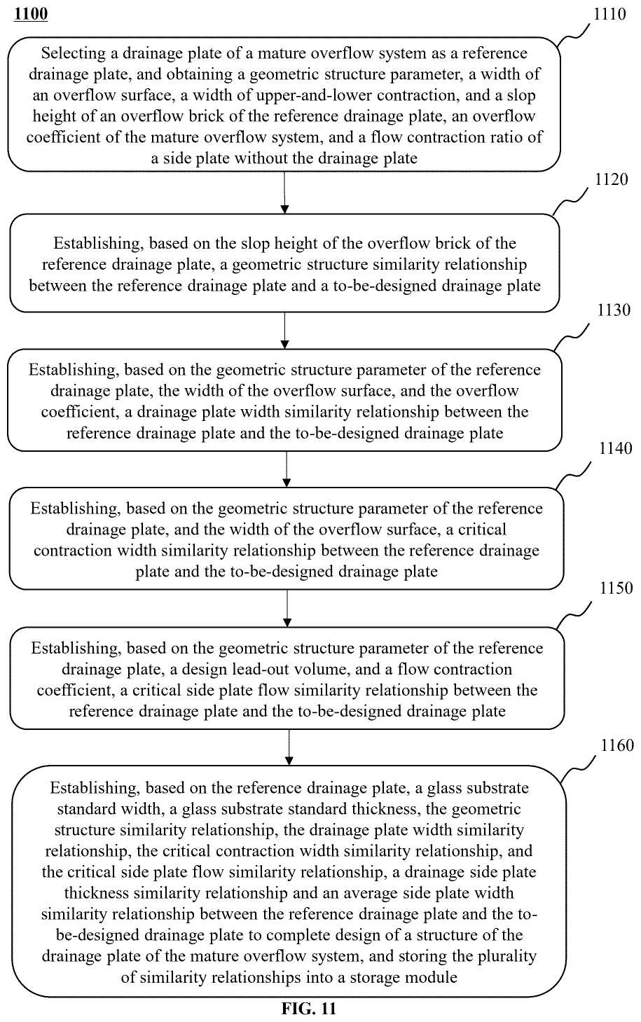

FIG. 11 is an exemplary flowchart illustrating a process for manufacturing a glass drainage plate based on a design system for the glass drainage plate manufactured based on a glass substrates using an overflow process according to some embodiments of the present disclosure. In some embodiments, process 1300 is performed by a processing device.

In 1110, a drainage plate of a mature overflow system is selected as a reference drainage plate, and a geometric structure parameter, a width of an overflow surface, an upper-and-lower contraction width, and a slope height of an overflow brick of the reference drainage plate, an overflow coefficient of the mature overflow system, and a flow contraction ratio of a side plate without the drainage plate are obtained, respectively.

In some embodiments, the geometric structure parameter includes a first height, a second height, a first width, and a second width. More details regarding this part may be found in later related description.

In some embodiments, the design module 260 may query historical manufacturing data to obtain the geometric structure parameter, the width of the overflow surface, the upper-and-lower contraction width, the slope height of the overflow brick of the reference drainage plate, the overflow coefficient of the overflow system, and the flow contraction ratio of the side plate without the drainage plate. In some embodiments, the geometric structure parameter, the width of the overflow surface, the upper-and-lower contraction width, the slope height of the overflow brick of the reference drainage plate, the overflow coefficient of the overflow system, and the flow contraction ratio of the side plate without the drainage plate may also be determined by user input. The present disclosure does not limit the obtaining manner.

In 1120, a geometric structure similarity relationship between the reference drainage plate and a to-be-designed drainage plate is established based on the slope height of the overflow brick of the reference drainage plate.

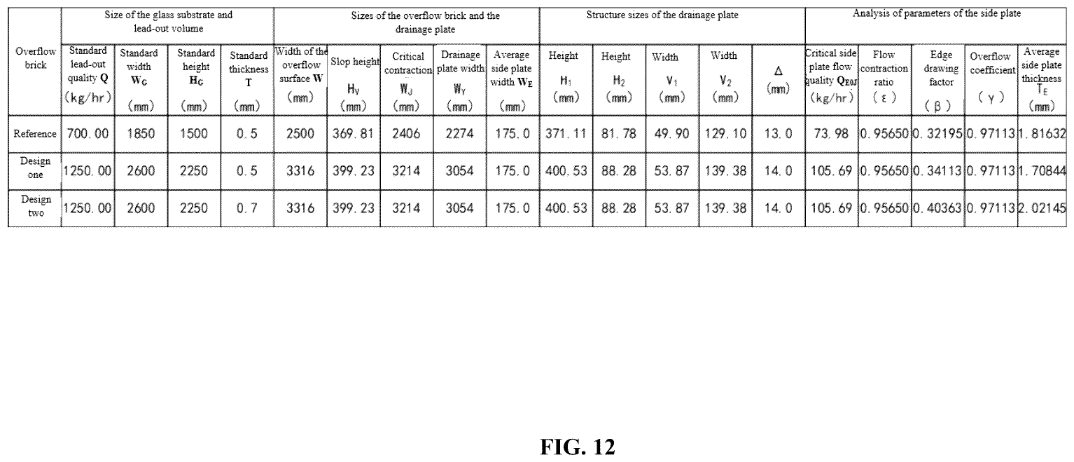

FIG. 12 is an exemplary tabular schematic diagram illustrating a structure and related parameters of a drainage plate of a reference overflow system and a drainage plate of a to-be-designed overflow system according to some embodiments of the present disclosure. As shown in FIG. 12, a structure size of a reference drainage plate of a reference overflow system includes: H_{10ref}=371.11 mm, H_{20ref}=81.78 mm, V_{10ref}=49.90 mm, V_{20ref}=129.10 mm and Δ_{ref}=13.0 mm, which are a standard first height, a standard second height, a standard first width, a standard second width, and a standard upper-and-lower contraction width of the reference drainage plate, respectively, and H_{Vref} is a slope height of a reference overflow brick, H_{Vref}=269.81 mm, at which time the glass stably flows out from a plate tip of the reference drainage plate.

A structure size of a to-be-designed drainage plate of a to-be-designed overflow system includes: H₁₀=400.53 mm, H₂₀=88.28 mm, V₁₀=53.87 mm, V₂₀=139.38 mm and Δ₀=14.0 mm, which are a standard first height, a standard second height, a standard first width, a standard second width, and a standard upper-and-lower contraction width of the to-be-designed drainage plate, respectively, and H_{V} is a slope height of a to-be-designed overflow brick, H_{V}=399.23 mm, at which time the glass stably flows out from a plate tip of the to-be-designed drainage plate.

In some embodiments, a relational formula for the geometric structure similarity relationship, which is established by the design module 260 based on the slope height of the overflow brick of the reference drainage plate, is as follows:

$${H}_{10} = {H}_{10 ref} \times \frac{{H}_{V}}{{H}_{Vref}} \qquad ( 1 )$$

$${H}_{20} = {H}_{20 ref} \times \frac{{H}_{V}}{{H}_{Vref}} \qquad ( 2 )$$

$${V}_{10} = {V}_{10 ref} \times \frac{{H}_{V}}{{H}_{Vref}} \qquad ( 3 )$$

$${V}_{20} = {V}_{20 ref} \times \frac{{H}_{V}}{{H}_{Vref}} \qquad ( 4 )$$

$${Δ}_{0} = {Δ}_{ref} \times \frac{{H}_{V}}{{H}_{Vref}} , \qquad ( 5 )$$

wherein H₁₀, H₂₀, V₁₀, V₂₀, and Δ₀ are the standard first height, the second height, the standard first width, the standard second width, and the standard upper-and-lower contraction width of the to-be-designed drainage plate, respectively. H_{10ref}, H_{20ref}, V_{10ref}, V_{20ref}, and Δ_{ref} are the standard first height, the standard second height, the standard first width, the standard second width, and the standard upper-and-lower contraction width of the reference drainage plate, respectively; H_{V} is the slope height of the to be designed overflow brick; and H_{Vref} is the slope height of the reference overflow brick. When the first height, the second height, the first width, and the second width are standard, the glass stably flows out from the plate tip of the to-be-designed drainage plate or the reference drainage plate.

The above to-be-designed drainage plate is a drainage plate to be designed for production, and the to-be-designed overflow brick is an overflow brick to be designed for production.

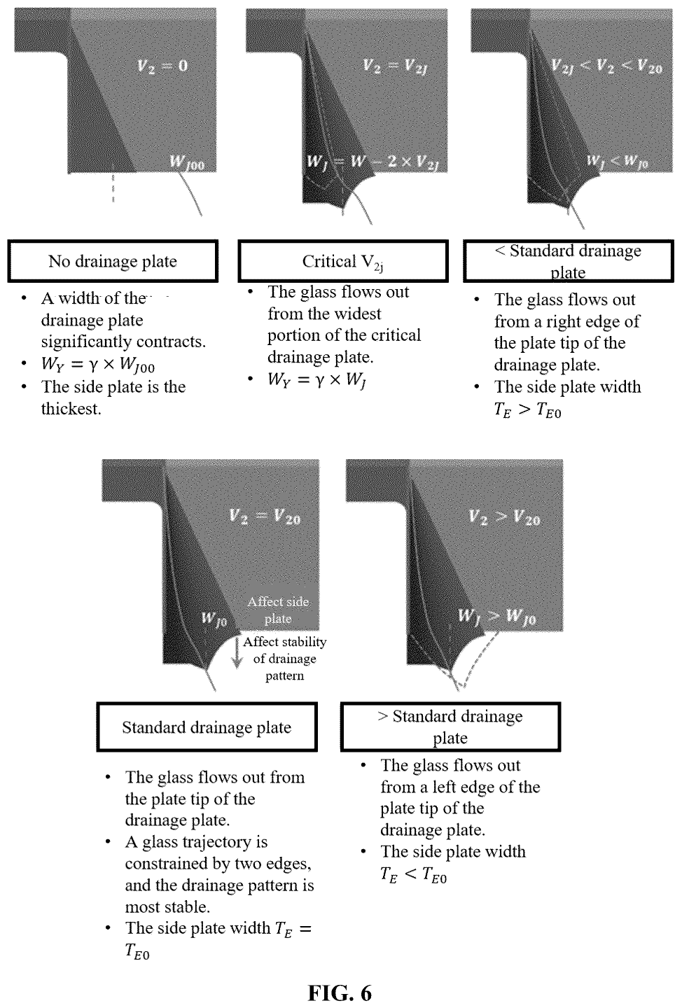

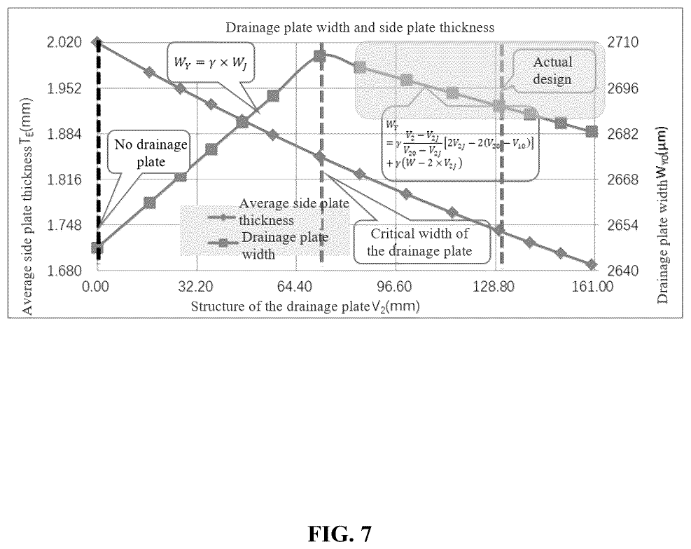

FIG. 6 is a schematic diagram illustrating a change relationship between a width V₂ of a drainage plate and a flow pattern of a side plate according to some embodiments of the present disclosure; and FIG. 7 is a schematic diagram illustrating a change trend of a width V₂ of a drainage plate, an average side plate thickness, and a drainage plate width according to some embodiments of the present disclosure. As shown in FIG. 6 and FIG. 7, when V₂=V₂₀, the glass flows out from a plate tip of the drainage plate, a glass trajectory is constrained by two edges, and the drainage pattern and the side plate thickness are most stable. When V₂ⱼ<V₂<V₂₀, the glass flows out from a right edge of the plate tip of the drainage plate, and the side plate thickness tends to be relatively thick (trace). When V₂=V₂ⱼ, the glass flows out from a critical position the widest portion of the drainage plate. When V₂=0, It is equivalent to no drainage plate, and the width of the drainage plate significantly contracts. When V₂>V₂₀, the glass flows out from a left edge of the plate tip of the drainage plate, and the side plate thickness tends to be relatively thick (trace).

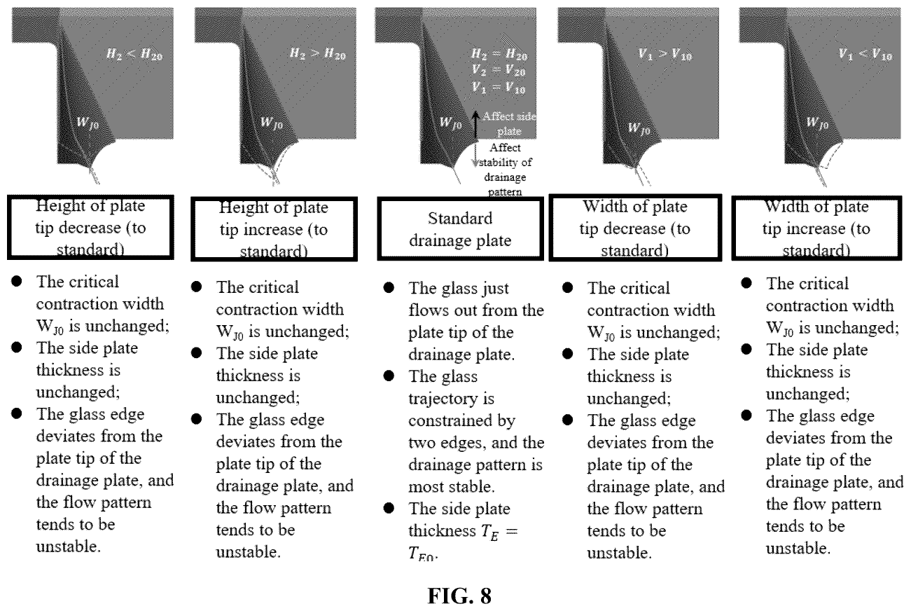

FIG. 8 is a schematic diagram illustrating a change relationship between a height H₂ and a width V₁ of a drainage plate and a flow pattern of a side plate according to some embodiments of the present disclosure. As shown in FIG. 8, when H₂=H₂₀, V₂=V₂₀, and V₁=V₁₀, the glass flows out from a plate tip of the drainage plate, the glass trajectory is constrained by two edges, and the drainage pattern and the side plate thickness are most stable. When H₂>H₂₀ or H₂<H₂₀, a critical contraction width and the side plate thickness are unchanged, the glass edge is deviated from the plate tip of the drainage plate, and the flow pattern tends to be unstable. When V₁>V₁₀ or V₁<V₁₀, the critical contraction width and the side plate thickness are unchanged, the glass edge is deviated from the plate tip of the drainage plate, and the flow pattern tends to be unstable.

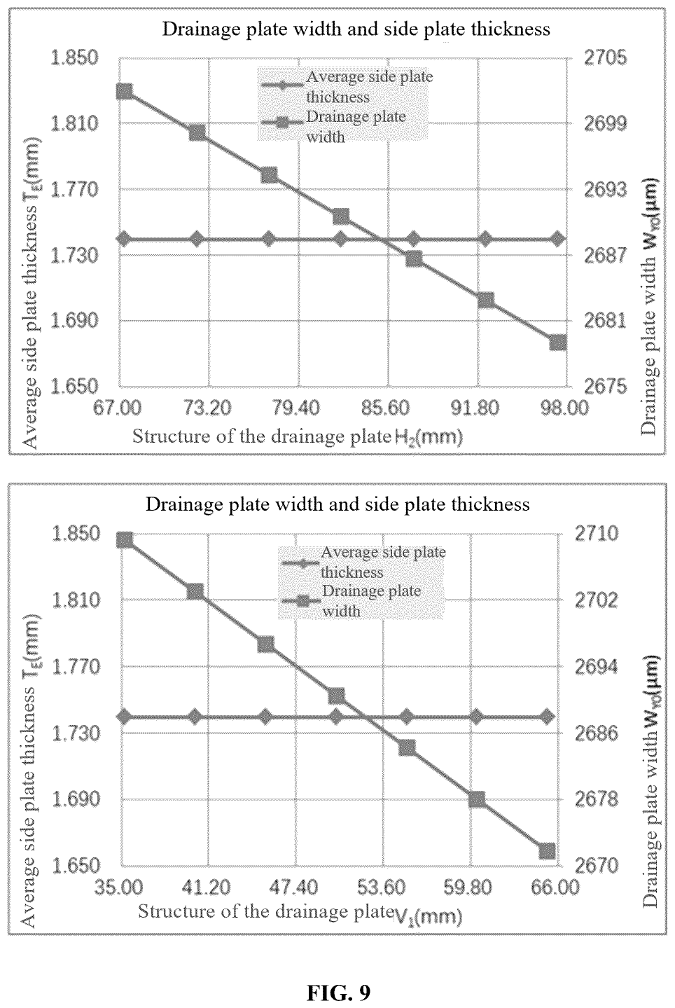

FIG. 9 is a schematic diagram illustrating a change trend of a height H₂ and a width V₁ of a drainage plate, an average side plate thickness, and a drainage plate width according to some embodiments of the present disclosure. In some embodiments, as shown in FIG. 6-FIG. 9, the structure size of the drainage plate satisfies:

$$\frac{{H}_{2}}{{H}_{20}} = \frac{{V}_{1}}{{V}_{10}} = \frac{{V}_{2}}{{V}_{20}} . \qquad ( 6 )$$

In some embodiments, an actual structure size of the to-be-designed drainage plate satisfies:

$$\frac{{H}_{1}}{{H}_{10}} = \frac{{H}_{2}}{{H}_{20}} = \frac{{V}_{1}}{{V}_{10}} = \frac{{V}_{2}}{{V}_{20}} = \frac{Δ}{{Δ}_{0}} , \qquad ( 7 )$$

wherein H₁, H₂, V₁, V₂ and Δ are an actual first height, an actual second height, an actual first width, an actual second width, and an actual upper-and-lower contraction width of the to-be-designed drainage plate, respectively, at which time the glass deviates from the plate tip of the drainage plate and flows out, and the greater the deviation, the worse a drainage stability; H₁₀, H₂₀, V₁₀, V₂₀, and Δ₀ are the standard first height, the standard second height, the standard first width, the standard second width, and the standard upper-and-lower contraction width of the to-be-designed drainage plate, respectively, at which time the glass stably flows out from the plate tip of the to-be-designed drainage plate.

In 1130, a drainage plate width similarity relationship between the reference drainage plate and the to-be-designed drainage plate is established based on the geometric structure parameter of the reference drainage plate, the width of the overflow surface, and the overflow coefficient.

In some embodiments, as shown in FIG. 12, W_{Yref} is the drainage plate width of the reference overflow system, W_{Yref}=2274 mm, W_{Jref} is the critical contraction width of the reference overflow system, W_{Jref}=3214 mm.

The structure size of the to-be-designed drainage plate of the to-be-designed overflow system includes: H₁₀=400.53 mm, H₂₀=88.28 mm, V₁₀=53.87 mm, and V₂₀=139.38 mm, which are the standard first height, the standard second height, the standard first width, and the standard second width of the to-be-designed drainage plate, respectively, and H_{V} is a slope height of a to-be-designed overflow brick, H_{V}=399.23 mm, at which time the glass stably flows out from the plate tip of the to-be-designed drainage plate. W_{Y} is the drainage plate width of the to-be-designed overflow system, W_{Y}=3054 mm, and W_{Y} is the critical contraction width, W_{J}=3214 mm.

In some embodiments, a relational formula for the drainage plate width similarity relationship, which is established by the design module 260 based on the geometric structure parameter of the reference drainage plate, the width of the overflow surface, and the overflow coefficient, is as follows:

$${W}_{Y} = γ \times ( \frac{{H}_{2}}{{H}_{20}} + \frac{{V}_{1}}{{V}_{10}} - 2 ) \times \{ [ W - 2 \times ( {V}_{20} - {V}_{10} ) ] - {W}_{J 0} \} + γ \times [ W - 2 \times ( {V}_{20} - {V}_{10} ) ] , \qquad ( 8 )$$

wherein H₂ and V₁ are the actual second height and the actual first width of the to-be-designed drainage plate, W is the width of the overflow surface of the to-be-designed overflow system, and γ is the overflow coefficient, γ=0.97113.

In 1140, a critical contraction width similarity relationship between the reference drainage plate and the to-be-designed drainage plate is established based on the geometric structure parameter of the reference drainage plate, and the width of the overflow surface.

In some embodiments, as shown in FIG. 12, W_{Jref} is the critical contraction width of the reference overflow system, W_{Jref}=3214 mm, and H_{Vref} is the slope height of the reference overflow brick, H_{Vref}=269.81 mm. The structure size of the to-be-designed drainage plate for the to-be-designed overflow system includes: V₁₀=53.87 mm and V₂₀=139.38 mm, which are the standard first width and the standard second width of the to-be-designed drainage plate, and H_{V} is the slope height of the to-be-designed overflow brick, H_{V}=399.23 mm.

In some embodiments, a relational formula for the critical contraction width similarity relationship, which is established by the design module 260 based on the geometric structure parameter of the reference drainage plate and the width of the overflow surface, is as follows:

$${W}_{J} = ( W - 202.71 \times \frac{{H}_{V}}{{H}_{Vref}} ) + 108.49 \times \frac{{V}_{2}}{{V}_{20}} \times \frac{{H}_{V}}{{H}_{Vref}} , \qquad ( 9 )$$

wherein V₂ is the actual second width of the to-be-designed drainage plate.

In 1150, a critical side plate flow similarity relationship between the reference drainage plate and the to-be-designed drainage plate is established based on the geometric structure parameter of the reference drainage plate, a design lead-out quality, and a flow contraction coefficient.

In some embodiments, as shown in FIG. 12, Q_{E0Jref} is the critical side plate flow quality of the reference overflow system, Q_{E0Jref}=73.98 Kg/hr. The structure size of the to-be-designed drainage plate for the to-be-designed overflow system includes: V₁₀=53.87 mm and V₂₀=139.38 mm, which are the standard first width and the standard second width of the to-be-designed drainage plate. Q_{E0J} is the critical side plate flow quality of the to-be-designed overflow system, Q_{E0J}=105.69 Kg/hr.

In some embodiments, a relational formula for the critical side plate flow similarity relationship, which is established by the design module 260 based on the geometric structure parameter of the reference drainage plate, the design lead-out quality, and the flow contraction coefficient, is as follows:

$${Q}_{E 0 J} = {Q}_{E 0} \times [ \frac{{V}_{2}}{{V}_{20}} \times ( 1 - ε ) + ε ] , \qquad ( 10 )$$

wherein Q_{E0} is the uncontracted average side plate flow quality, i.e., a side plate flow quality before entering an inclined plane of the overflow brick; ε is a flow contraction ratio of the side plate without the drainage plate, ε=0.95650.

In some embodiments, a formula for determining the uncontracted average side plate flow quality Q_{E0} is as follows:

$${Q}_{E 0} = \frac{Q}{2} \times ( 1 - \frac{{W}_{G}}{W} ) , \qquad ( 11 )$$

wherein Q is the design lead-out quality for manufacturing the glass substrate, W_{G} is the standard width of the glass substrate, and W is the width of the overflow surface of the to-be-designed overflow system.

In 1160, based on the reference drainage plate, a standard width of a glass substrate, a standard thickness of the glass substrate, the geometric structure similarity relationship, the drainage plate width similarity relationship, the critical contraction width similarity relationship, and the critical side plate flow similarity relationship, a drainage side plate thickness similarity relationship and an average side plate width similarity relationship between the reference drainage plate and the to-be-designed drainage plate are established to complete design of a structure of the drainage plate of the mature overflow system, and the plurality of similarity relationships are stored into the storage module.

In some embodiments, as shown in FIG. 12, Q_{E0Jref} is the critical side plate flow quality of the reference overflow system,

$${Q}_{E 0 Jref} = \frac{73 \text{.98} Kg}{h r} ,$$

W_{Jref} is the critical contraction width, W_{Jref}=2406 mm, and T_{Eref} is the average side plate thickness, T_{Eref}=1.81632 mm. Q_{E0J} is the critical side plate flow quality of the to-be-designed overflow system,

$${Q}_{E 0 J} = \frac{105.69 Kg}{hr} ,$$

T_{E} is the average side plate thickness, T_{E}=1.78044 mm when the standard thickness of the side plate is 0.5 mm, and T_{E}=2.02145 mm when the standard thickness of the side plate is 0.7 mm.

In some embodiments, a relational formula for the drainage side plate thickness similarity relationship, which is established by the design module 260 based on the reference drainage plate, the standard width of the glass substrate, the standard thickness of the glass substrate, the geometric structure similarity relationship, the drainage plate width similarity relationship, the critical contraction width similarity relationship, and the critical side plate flow similarity relationship, is as follows:

$${T}_{E} = T \times \frac{{W}_{G}}{( {W}_{J} - {W}_{G} ) \times β} \times \frac{2 \times {Q}_{E 0 J}}{Q - 2 \times {Q}_{E 0 J}} , \qquad ( 12 )$$

where T is the standard thickness of the glass substrate, and β is an edge drawing factor of the side plate.

In some embodiments, a formula for determining the edge drawing factor of the side plate β is as follows:

$$β = 0.43507 \times \frac{{W}_{G}}{W} \times \sqrt{\frac{T}{0.5}} . \qquad ( 13 )$$

In some embodiments, as shown in FIG. 12, W_{Eref} is the drainage plate width of the reference overflow system, W_{Yref}=2274 mm, and W_{Eref} is the average side plate width, W_{Eref}=175 mm. W_{Y} is the width of the drainage plate of the to-be-designed overflow system, W_{Y}=3054 mm, and W_{E} is the average side plate width, W_{E}=175 mm.

In some embodiments, a relational formula for the average side plate width similarity relationship, which is established by the design module 260 based on the reference drainage plate, the standard width of the glass substrate, the standard thickness of the glass substrate, the geometric structure similarity relationship, the drainage plate width similarity relationship, the critical contraction width similarity relationship, and the critical side plate flow similarity relationship, is as follows:

$${W}_{E} = \frac{1}{2} \times ( {W}_{Y} - 1.04 \times {W}_{G} ) . \qquad ( 14 )$$

For any structure size of the drainage plate, there exists a critical second width size when the glass just flows out from the edge of the second width. In some embodiments, a preset algorithm for determining the critical second width size of the drainage plate is as follows:

$${V}_{2 J} = \frac{202.71 \times {V}_{20} \times \frac{{H}_{V}}{{H}_{Vref}}}{108.49 \times \frac{{H}_{V}}{{H}_{Vref}} + 2 \times {V}_{20}} . \qquad ( 15 )$$

In some embodiments, for any structure size of the drainage plate, specific formulas for determining the drainage plate width of the drainage plate are as follows:

$$when {V}_{2} \leq {V}_{2 J} : {W}_{Y} = γ \times {W}_{J} \qquad ( 16 )$$

$$when {V}_{2} > {V}_{2 J} : {W}_{Y} = γ \times \frac{{V}_{2} - {V}_{2 J}}{{V}_{20} - {V}_{2 J}} \times [ 2 \times {V}_{2 J} - 2 \times ( {V}_{20} - {V}_{10} ) ] + γ \times ( W - 2 \times {V}_{2 J} ) . \qquad ( 17 )$$

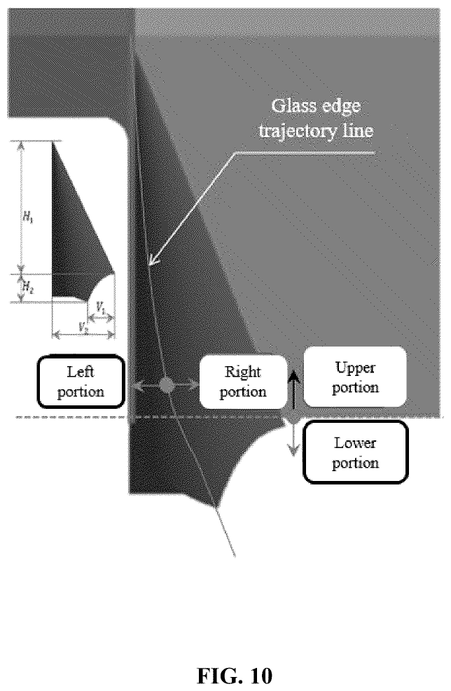

As shown in FIG. 10, (1) a left portion of the drainage plate does not play a wetting and widening effect on inner glass and does almost not affect the glass flow pattern, and any adjustment of the shape and size of the left portion almost does not affect the side plate thickness and the drainage plate width; (2) a right portion of the drainage plate plays a wetting and widening effect on the inner glass (overcoming the surface tension of the glass), and any adjustment of the shape and size of the left portion affects the side plate thickness and the drainage plate width, but the adjustment is limited by the stability requirement of the glass flow pattern at the plate tip of the drainage plate, and the structure adjustment is very limited; (3) an upper portion of the drainage plate plays a wetting and widening effect on the glass on the inclined plane of the overflow brick (overcoming the glass surface tension), and adjustment to the width V₂ significantly affects the side plate thickness and the drainage plate width, but the adjustment is limited by the stability requirement of the glass flow pattern at the plate tip of the drainage plate, and the structure adjustment is very limited; (4) a lower portion of the drainage plate plays an important role in stability of the flow pattern at the side plate (boundary constraint) and has almost no effect on the side plate thickness, but any adjustment of H₂ and V₁ has a certain impact on the drainage plate width.

According to the method of the present embodiment, more scientific design criteria and evaluation criteria for the design of the drainage plate with a large lead-out quality are provided, and technical requirements of high efficiency, targeting, digitalization, and parameterization are met, thereby satisfying the needs of higher generations and greater lead-out quality.

In some embodiments, the design module 260 may further optimize the to-be-implemented sizing parameter of the to-be-designed drainage plate and an overflow parameter.

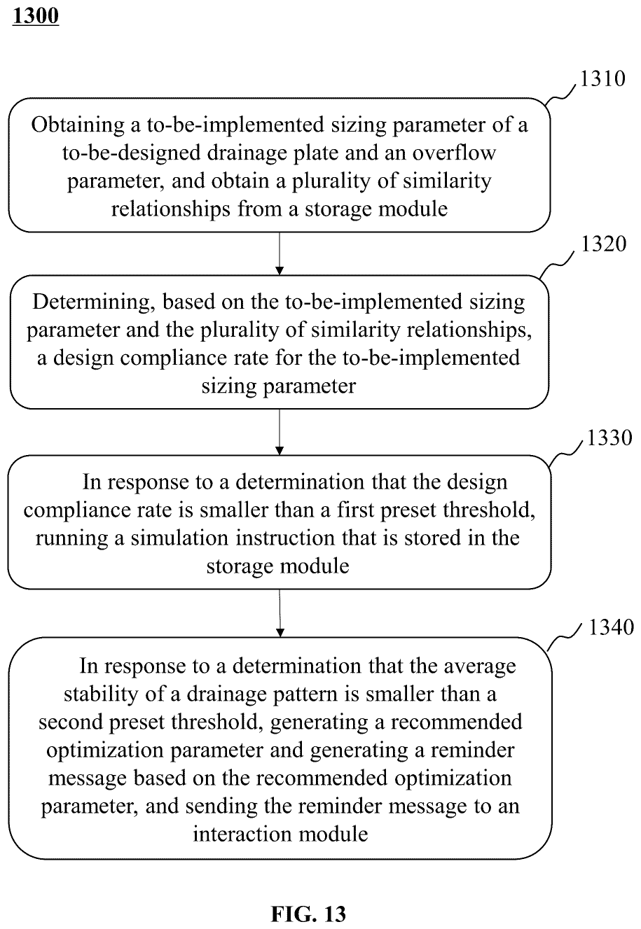

FIG. 13 is an exemplary flowchart illustrating a process for optimizing parameters of a to-be-designed drainage plate according to some embodiments of the present disclosure. In some embodiments, process 1300 is performed by a processing device.

In 1310, a to-be-implemented sizing parameter of the to-be-designed drainage plate and an overflow parameter are obtained, and a plurality of similarity relationships are obtained from a storage module.

In some embodiments, the to-be-implemented sizing parameter may include at least one of a first height, a second height, a first width, a second width, an upper-and-lower contraction width, or the like, of the to-be-designed drainage plate. The overflow parameter may include at least one of a standard thickness of the glass substrate, a standard width of a glass substrate, a flow contraction ratio of a side plate without a drainage plate, a slope height of an overflow brick, a drainage plate width, a critical contraction width, a critical side plate flow, an average side plate width, and an average side plate thickness.

In some embodiments, the design module 260 may preset the to-be-implemented sizing parameter of the to-be-designed drainage plate according to the demand, or based on a determination of a preset formula.

In some embodiments, the similarity relationships may include at least one of a geometric structure similarity relationship, a drainage plate width similarity relationship, a critical contraction width similarity relationship, a critical side plate flow similarity relationship, a drainage side plate thickness similarity relationship, and an average side plate width similarity relationship.

More descriptions regarding this part may be found in other contents of the present disclosure (e.g., descriptions in connection with FIG. 11).

In 1320, based on the to-be-implemented sizing parameter and the plurality of similarity relationships, a design compliance rate for the to-be-implemented sizing parameter is determined.

In some embodiments, the design module 260 may determine a plurality of ratios and a plurality of differences based on the to-be-implemented sizing parameter and the similarity relationships; and based on the plurality of ratios and the plurality of differences, determine the design compliance rate for the to-be-implemented sizing parameter.

In some embodiments, the design module 260 may determine, based on a first height in the to-be-implemented sizing parameter and a standard first height of the to-be-designed drainage plate, a first ratio and a first difference; determine, based on a second height in the to-be-implemented sizing parameter and a standard second height of the to-be-designed drainage plate, a second ratio and a second difference; determine, based on a first width in the to-be-implemented sizing parameter and a standard first width of the to-be-designed drainage plate, a third ratio and a third difference; determine, based on a second width in the to-be-implemented sizing parameter and a standard second width of the to-be-designed drainage plate, a fourth ratio and a fourth difference; and determine, based on an upper-and-lower contraction width in the to-be-implemented sizing parameter and a standard upper-and-lower contraction width of the to-be-designed drainage plate, a fifth ratio and a fifth difference.

In some embodiments, the design module 260 may determine a statistical value (e.g., a standard deviation or a variance, etc.) of the plurality of ratios, and determine a ratio compliance rate based on the statistical value of the plurality of ratios; determine a statistical value (e.g., a sum of absolute values, etc.) of the plurality of differences, and determine a difference compliance rate based on the statistical value of the plurality of differences; and finally determine the design compliance rate for the to-be-implemented sizing parameter based on the ratio compliance rate and the difference compliance rate. For example, the design module 260 may determine a result of k1/the statistical value of the plurality of ratios as the ratio compliance rate, determine a product of k2 and the statistical value of the plurality of differences as the difference compliance rate, and determine a sum of k3*ratio compliance rate and k4*difference compliance rate as the design compliance rate for the to-be-implemented sizing parameter.

In 1330, in response to a determination that the design compliance rate is smaller than a first preset threshold, a simulation instruction that is stored in the storage module is run.

The first preset threshold refers to a threshold condition for determining whether to run the simulation instruction. When the design compliance rate is smaller than the first preset threshold, the design module 260 may run the simulation instruction stored in the storage module.

In some embodiments, the first preset threshold may be preset based on historical data or empirical knowledge.

In some embodiments, the first preset threshold may be correlated to a regulation sensitivity of a glass substrate manufacturing system on a production line. In this content, the glass substrate manufacturing system refers to a system for actually manufacturing the glass substrate based on the to-be-implemented sizing parameter of the glass drainage plate. The glass substrate manufacturing system may communicate with the design system for the glass drainage plate to obtain the to-be-implemented sizing parameter determined by the design system for the glass drainage plate. The glass substrate manufacturing system may include sensor devices for monitoring a manufacturing process. More details regarding this part may be found in later related description.

The regulation sensitivity refers to a minimum step of a regulation of process parameters by various types of process regulation devices in the glass substrate manufacturing system. The process regulation devices include a temperature control device, a flow control device, or the like, and correspondingly, the process parameters include a temperature, a flow quality, or the like. The minimum step may be expressed as an average value, and the smaller the minimum step, the higher the regulation sensitivity. Taking temperature as an example, the minimum step for temperature control may be 0.1° C., 0.5° C., or the like. The minimum step may be determined by user input, or may be obtained by the design module 260 through the Internet of Things.

In some embodiments, the first preset threshold may be positively correlated to the regulation sensitivity of the glass substrate manufacturing system, and the higher the regulation sensitivity, the smaller the first preset threshold.

The higher the regulation sensitivity, the stronger the error correction capability of the production line. In this case, even if the difference between the size of the drainage plate and the standard size is too large, the quality of the output glass may be ensured by real-time regulation of the temperature and the flow. Therefore, the first preset threshold may be set relatively small.

In some embodiments, the simulation instruction is configured to perform a plurality of iterations, each iteration including at least one simulation, and an average stability of the drainage pattern is obtained based on results of a plurality of simulations.

The drainage pattern refers to a flow pattern of the glass after the glass is induced. The stability of the drainage pattern is a value used to measure whether the drainage pattern is stable. The stability of the drainage pattern may be measured by a deviation degree of a glass outflow point from the plate tip of the drainage plate.

In some embodiments, each iteration includes: establishing a simulation model of the to-be-designed overflow system based on the to-be-implemented sizing parameter; performing a simulation on the be-designed overflow system for manufacturing glass by the overflow process based on the simulation model, and determining a stability of the drainage pattern for the interaction. In this content, the overflow system includes at least an overflow brick, an overflow groove, a glass liquid feeding device, and a drainage plate. The simulation model of the to-be-designed overflow system may be a simulation model constructed by any feasible simulation software.

In some embodiments, the design module 260 may record, during a process of the simulation corresponding to each iteration, a deviation value of the glass boundary from the plate tip of the drainage plate at each of a plurality of time points, and determine an average value and a standard deviation of a plurality of deviation values; and, based on the average value and the standard deviation of the plurality of deviation values, determine the stability of the drainage pattern corresponding to each iteration.

In some embodiments, the deviation value may be positively correlated to a distance between the glass outflow point and a point at which the plate tip of the drainage plate is located, for example, the deviation value may be equal to the distance between the glass outflow point and the point at which the plate tip of the drainage plate is located.

In some embodiments, the stability of the drainage pattern corresponding to each iteration may be equal to f1/(average value+standard deviation+f2), wherein f1 and f2 are preset positive values.

The average stability of the drainage pattern refers to an average of the stabilities of a plurality of drainage patterns determined over the plurality of iterations, which is obtained by averaging.

In 1340, in response to a determination that the average stability is smaller than a second preset threshold, a recommended optimization parameter is generated, and a reminder message is generated based on the recommended optimization parameter, and the reminder message is sent to the interaction module.

The second preset threshold refers to a threshold condition for determining whether to generate the recommended optimization parameter. When the average stability is lower than the second preset threshold, the design module 260 may generate the recommended optimization parameter.

In some embodiments, the second preset threshold may be preset based on historical data or empirical knowledge. In some embodiments, similar to the first preset threshold, the second preset threshold may be related to the regulation sensitivity of the glass substrate manufacturing system.

The recommended optimization parameter refers to an optimized value for size parameters of the to-be-designed drainage plate. In some embodiments, the recommended optimization parameter may include at least one of an optimized first height, an optimized second height, an optimized first width, an optimized second width, and an optimized upper-and-lower contraction width.

In some embodiments, the design module 260 may determine a standard parameter as the recommended optimization parameter. The standard parameter includes at least one of the standard first height, the standard second height, the standard first width, the standard second width, and the standard upper-and-lower contraction width.

In some embodiments, the design module 260 may determine an average value of the first ratio, the second ratio, the third ratio, the fourth ratio, and the fifth ratio as a target ratio; determine the optimized first height based on the target ratio and the standard first height; determine the optimized second height based on the target ratio and the standard second height; determine the optimized first width based on the target ratio and the standard first width; determine the optimized second width based on the target ratio and the standard second width; and determine the optimized upper-and-lower contraction width based on the target ratio and the standard upper-and-lower contraction width. For example, the design module 260 may determine a product of the target ratio and the standard first height as the optimized first height, a product of the target ratio and the standard second height as the optimized second height, a product of the target ratio and the standard first width as the optimized first width, a product of the target ratio and the standard second width as the optimized second width; and a product of the target ratio and the standard upper-and-lower contraction width as the optimized upper-and-lower contraction width.

In some embodiments, the design module 206 may determine the average value of the first ratio, the second ratio, the third ratio, the fourth ratio, and the fifth ratio; generate a plurality of candidate ratios based on the average value; for each candidate ratio of the plurality of candidate ratios, generate a set of candidate optimization parameters; predict, using a prediction model, a predicted stability corresponding to each set of candidate optimization parameters; simulate a set of candidate optimization parameters for which the corresponding predicted stability is greater than a third preset threshold, and determine the average stability of the drainage pattern corresponding to the each set of candidate optimization parameters; and sort a plurality of average stabilities in a descending order, and determine N sets of candidate optimization parameters corresponding to first N average stabilities, as N sets of recommended optimization parameters. In this content, N may be a preset value.

In some embodiments, the design module 260 may generate the plurality of candidate ratios by increasing or decreasing the average value based on the above average value in a preset step. The preset step and a count of the plurality of candidate ratios to generate may be preset based on experience. For example, if the average value is 0.5, and the preset step is 0.05, then the design module 260 may generate the plurality of candidate ratios accordingly including 0.35, 0.40, 0.45, 0.5, 0.55, 0.65, 0.7, or the like.

In some embodiments, for each candidate ratio, the design module 260 may determine the optimized first height corresponding to the candidate ratio based on the candidate ratio and the standard first height; determine the optimized second height corresponding to the candidate ratio based on the candidate ratio and the standard second height; determine the optimized first width corresponding to the candidate ratio based on the candidate ratio and the standard first width; determine the optimized second width corresponding to the candidate ratio based on the candidate ratio and the standard second width; and determine the optimized upper-and-lower contraction width corresponding to the candidate ratio based on the candidate ratio and the standard upper-and-lower contraction width.

In some embodiments, generating the optimized parameter corresponding to the candidate ratio based on the candidate ratio is performed in the same manner as generating the optimized parameter corresponding to the target ratio based on the target ratio, and will not be repeated herein.

The prediction model refers to a model for determining the predicted stability corresponding to the candidate optimization parameter. In some embodiments, the prediction model may be a machine learning model. For example, the prediction model may include one or a combination of a Convolutional Neural Networks (CNN) model, a Neural Networks (NN) model, or other customized model structure.

In some embodiments, an input of the prediction model includes a set of candidate optimization parameters and the overflow parameter, and an output include the predicted stability corresponding to the set of candidate optimization parameters.

In some embodiments, the prediction model may be obtained by training based on a plurality of first training samples with a first label. The design module 260 may perform the following training process to obtain the prediction model. The training process includes: obtaining the plurality of first training samples with the first label to form a first training sample set, and performing a plurality of iterations based on the first training sample set. In this content, at least one iteration includes: selecting one or more first training samples from the first training sample set, inputting the one or more first training samples into an initial prediction model, and obtaining one or more first prediction outputs corresponding to the one or more first training samples; determining a value of a predefined first loss function by substituting the first prediction outputs and the first label into a formula for the first loss function; and iteratively updating model parameters of the initial prediction model according to the value of the first loss function until a first iteration end condition is satisfied, ending the plurality of iterations and obtaining a trained prediction model. In this content, iteratively updating the model parameters of the initial prediction model may be carried out by a plurality of ways, for example, the updating may be carried out based on a gradient descent manner. The first iteration end condition may include that the second loss function converges, a count of iterations reaches a count threshold, or the like.

In some embodiments, the first training samples may include sample optimization parameters and sample overflow parameters, and the corresponding first label may be the predicted stability corresponding to the set of sample optimization parameters. The first training samples and the first label may be determined based on historical data. For example, the design module 260 may construct the corresponding first training samples and the first label based on real production data, the first label being a stability of the drainage pattern of the glass during the actual production process.

In some embodiments, different first training samples correspond to different learning rates, and each learning rate for each first training sample is determined based on the design compliance rate corresponding to the first training sample. For example, the lower the design compliance rate corresponding to the first training sample, the greater the learning rate corresponding to the first training sample.

The first training samples with a higher design compliance rate are more compatible with the standard size, therefore, a probability of higher stability of the drainage pattern is also higher. For the first training samples with a higher design compliance rate, implied feature information is low, therefore, it is not appropriate to focus on learning the features. For the first training samples with a lower design compliance rate, the uncertainty is greater, therefore, the implied feature information is more. It is a more important task for the prediction model to accurately predict the first training samples with the lower design compliance rate, so that the learning rate for such first training samples may be larger.

The third preset threshold refers to a threshold condition for determining whether to simulate the candidate optimization parameters. When the predicted stability is greater than the third preset threshold, the design module 260 may perform the simulation on the candidate optimization parameters.

In some embodiments, the third preset threshold may be preset based on historical data or empirical knowledge. In some embodiments, the third preset threshold is related to a computational performance of the design module 260, the computational performance being determined based on an available hardware resource of the design module 260. For example, the computational performance of the design module 260 may be measured based on a count of CPU cores, an amount of memories, I/O resources, or the like, that the design module 260 may allocate or schedule. The third preset threshold may be negatively correlated to the computational performance of the design module 260, i.e., the stronger the computational performance of the design module 260, the smaller the third preset threshold.

In some embodiments, the design module 260 may simulate the candidate optimization parameters for which the predicted stability is higher than the third preset threshold. The simulation based on the candidate optimization parameters is performed in a similar manner to simulation based on the to-be-implemented sizing parameters, and will not be repeated herein.

When a larger number of sets of candidate optimization parameters are generated, simulating for each set of candidate optimization parameters may lead to a significant increase in computing time. Therefore, pre-training the prediction model to predict the stability, and selecting only the candidate optimization parameters with a higher predicted stability for simulation, may greatly reduce resource consumption.

In some embodiments of the present disclosure, when the design compliance rate of the to-be-implemented sizing parameters is lower than the first preset threshold, the to-be-implemented sizing parameters may be simulated to determine whether to make a recommendation to the user. By determining the average stability of the drainage pattern through the plurality of iterations, the recommended optimization parameter may be generated to optimize the to-be-implemented sizing parameters of the to-be-designed drainage plate when the average stability is lower than the second preset threshold and to improve recommendation accuracy of the design system for the glass drainage plate.

In some embodiments, the design system for the glass drainage plate may further include a control module. In some embodiments, the control module communicates with a glass substrate manufacturing system on a production line to obtain a sizing parameter of an actually used drainage plate in the glass substrate manufacturing system; determines a design compliance rate for the actually used drainage plate based on the sizing parameter of the actually used drainage plate and the similarity relationships; and generates a preferred monitoring parameter based on the design compliance rate of the actually used drainage plate, and sends the preferred monitoring parameter to the glass substrate manufacturing system.

In some embodiments, the sizing parameter of the actually used drainage plate in the glass substrate manufacturing system may include at least one of a first height, a second height, a first width, a second width, an upper-and-lower contraction width, or the like.

In some embodiments, determining the design compliance rate for the actually used drainage plate based on the sizing parameter of the actually used drainage plate and the similarity relationships is performed in a manner similar to determining the design compliance rate for the to-be-implemented sizing parameter based on the to-be-implemented sizing parameter and the similarity relationships.

The preferred monitoring parameter refers to a monitoring parameter that is preferably determined. In some embodiments, the monitoring parameter may include a count of deployed sensors, a frequency of data collection, or the like. In this content, the sensors include, but are not limited to, an image sensor, a temperature sensor, a flow sensor, or the like. The glass substrate manufacturing system may monitor a manufacturing process of manufacturing the glass substrate based on the preferred monitoring parameter.

In some embodiments, the design module 260 may determine the preferred monitoring parameter by querying a first preset table based on the design compliance rate of the actually used drainage plate. In some embodiments, the first preset table includes a correspondence between the design compliance rate and the preferred monitoring parameter. The first preset table may be constructed based on historical data. In some embodiments, the design module 260 may select, among historical production data, monitoring parameters during a historical time period with effective monitoring and the design compliance rate of the actually used drainage plate in the historical time period to construct the first preset table.

In some embodiments, the control module is further configured to: obtain sensing data from the glass substrate manufacturing system during the production of the glass substrate; determine, based on the sensing data, a quality feature of an output glass substrate by a quality assessment model; generate, based on the quality feature, a corresponding warning message.

In some embodiments, the sensed data includes at least image data, which may be obtained based on the preferred monitoring parameter.

The quality assessment model refers to a model for determining the quality feature of the output glass substrate. In some embodiments, the quality assessment model may be a machine learning model. For example, the quality assessment model may include any one or a combination of a convolutional neural network model, a neural network model, or other customized model structure.

In some embodiments, an input of the quality assessment model includes the sensing data, and an output includes the quality feature of the output glass substrate.

In some embodiments, the input of the quality assessment model further includes the sizing parameter of the actually used drainage plate and the design compliance rate of the actually used drainage plate. The sizing parameter and the design compliance rate clearly affect the quality of the output glass substrate, and thus inputting these relevant features may help to improve the assessment accuracy of the quality assessment model.

In some embodiments, the quality assessment model may be obtained by training based on a plurality of second training samples with a second label. The design module 260 may perform the following training process to obtain the quality assessment model. The training process includes: obtaining the plurality of second training samples with the second label to form a second training sample set, and performing a plurality of iterations based on the second training sample set. In this content, at least one iteration includes: selecting one or more second training samples from the second training sample set, inputting the one or more second training samples into an initial quality assessment model, and obtaining one or more second prediction outputs corresponding to the one or more second training samples; determining a value of a predefined second loss function by substituting the second prediction outputs and the second label into a formula for the second loss function; and iteratively updating model parameters of the initial quality assessment model according to the value of the second loss function until a second iteration end condition is satisfied, ending the plurality of iterations and obtaining a trained quality assessment model. In this content, iteratively updating the model parameters of the initial quality assessment model may be carried out by a plurality of ways, for example, it may be carried out based on a gradient descent manner. The second iteration end condition may include that the second loss function converges, a count of iterations reaches a count threshold, or the like.

In some embodiments, the second training samples may include sample sensing data, a corresponding second label may be a quality feature of an actually output glass substrate. In some embodiments, when the input of the quality assessment model further includes the sizing parameter of the actually used drainage plate and the design compliance rate of the actually used drainage plate, the corresponding second training samples thereof may further include a sample sizing parameter of the actually used drainage plate and a sample design compliance rate of the actually used drainage plate.

In some embodiments, the second training samples and the second label may be determined based on historical data. For example, the design module 260 may construct corresponding second training samples and second label based on real production data, the second label being the quality feature of the output glass substrates during the actual production process.

In some embodiments, the design module 260 may generate the corresponding warning message based on the quality feature in a plurality of ways. For example, the warning message is generated when the quality is poor. The poor quality may include that a feature value of the quality feature is smaller than a feature value threshold. In this content, the feature value of the quality feature may be a vector value, or the like.

In some embodiments, the warning message may include: a quality problem that occurs, a possible cause of the quality problem, or the like. In this content, the quality problem that occurs includes cracks on a finished glass plate, or the like; and the possible cause of the quality problem includes a certain sizing parameter of the drainage plate that causes the problem, or the like.

In some embodiments, the design module 260 may determine the possible cause of the quality problem based on the quality feature. For example, the design module 260 may query a second preset table to determine the possible cause of the quality problem based on the quality feature.

In some embodiments, the second preset table includes a correspondence between the quality feature and the cause. The second preset table may be constructed based on historical data. In some embodiments, the design module 260 may select historical data with quality problems from the historical production data and construct the second preset table based on the actual causes determined after diagnosing the faults or quality problems.

When describing the operations performed in the embodiments of the present disclosure in terms of the steps, the order of the steps is all interchangeable if not otherwise indicated, the steps may be omitted, and other steps may be included in the process of operation.

The description of the system and its modules in the embodiments of the present disclosure is for descriptive convenience only, and is not to be limited to the scope of the cited embodiments. It may be possible to make any combination of modules or to form subsystems to be connected to other modules without departing from the principles of the system.

The embodiments in the present disclosure are for the purpose of exemplification and illustration only and do not limit the scope of application of the present disclosure. For those skilled in the art, the various corrections and alterations that can be made under the guidance of the present disclosure remain within the scope of the present disclosure.

Some features, structures, or characteristics of one or more embodiments of the present disclosure may be suitably combined.

Aspects of this manual may be performed entirely by hardware, entirely by software (including firmware, resident software, microcode, etc.), or by a combination of hardware and software. All the above hardware or software may be referred to as a “block”, “module”, “engine”, “unit”, “component”, or “system”. Additionally, aspects of the present disclosure may be manifested as a computer product disposed in one or more computer-readable mediums, the product comprising computer-readable program code.

Computer storage media may be any computer-readable medium that may be used to communicate, disseminate, or transmit a program for use by connecting to an instruction execution system, device, or apparatus. The program code located on the computer storage medium may be disseminated via any suitable medium, including a radio, cable, fiber optic cable, RF, or the like, or any combination of the foregoing.

The computer program code required for the operation of the various sections of this instruction manual may be written in any one or more of the programming languages. The program code may be run entirely on the computer of a user, or as a stand-alone software package on the computer of the user, or partly on the computer of the user and partly on a remote computer, or entirely on a remote computer or processing device. In the latter case, the remote computer may be connected to the computer of the user through any form of network, such as a local area network (LAN) or wide area network (WAN), or connected to an external computer (e.g., via the Internet), or in a cloud computing environment, or used as a service such as software as a service (SaaS).

Some embodiments use numbers to describe the number of components, attributes, and it should be understood that such numbers used in the description of the embodiments are modified in some examples by the modifiers “about”, “approximately”, or “substantially”. Unless otherwise noted, the terms “about,” “approximately,” or “substantially” indicates that a ±20% variation in the stated number is allowed. Correspondingly, in some embodiments, the numerical parameters used in the present disclosure and claims are approximations, which can change depending on the desired characteristics of individual embodiments. While the numerical domains and parameters used in some embodiments of the present disclosure to confirm the breadth of their ranges are approximations, in specific embodiments such values are set to be as precise as possible within a feasible range.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

1-10. (canceled)

11. A design system for a glass drainage plate manufactured based on a glass substrate using an overflow process, comprising an obtaining module, a geometric structure similarity module, a drainage plate width similarity module, a critical contraction width similarity module, a critical side plate flow similarity module, a design module, a storage module, and an interaction module; wherein
the obtaining module is configured to: select a drainage plate of a mature overflow system as a reference drainage plate, and obtain a geometric structure parameter, a width of an overflow surface, a width of upper-and-lower contraction, and a slope height of an overflow brick of the reference drainage plate, an overflow coefficient of the mature overflow system, and a flow contraction ratio of a side plate without the drainage plate;
the geometric structure similarity module is configured to: establish, based on the slope height of the overflow brick of the reference drainage plate, a geometric structure similarity relationship between the reference drainage plate and a to-be-designed drainage plate;
the drainage plate width similarity module is configured to: establish, based on the geometric structure parameter of the reference drainage plate, the width of the overflow surface, and the overflow coefficient, a drainage plate width similarity relationship between the reference drainage plate and the to-be-designed drainage plate;
the critical contraction width similarity module is configured to: establish, based on the geometric structure parameter of the reference drainage plate and the width of the overflow surface, a critical contraction width similarity relationship between the reference drainage plate and the to-be-designed drainage plate;
the critical side plate flow similarity module is configured to: establish, based on the geometric structure parameter of the reference drainage plate, a design lead-out quality, and a flow contraction coefficient, a critical side plate flow similarity relationship between the reference drainage plate and the to-be-designed drainage plate;
the design module is configured to: establish, based on the reference drainage plate, a standard width of a glass substrate, a standard thickness of the glass substrate, the geometric structure similarity relationship, the drainage plate width similarity relationship, the critical contraction width similarity relationship, and the critical side plate flow similarity relationship, a drainage side plate thickness similarity relationship and an average side plate width similarity relationship between the reference drainage plate and the to-be-designed drainage plate to complete design of a structure of the drainage plate of the mature overflow system, and store the plurality of similarity relationships into the storage module; and
the design module is further configured to:
obtain a to-be-implemented sizing parameter of the to-be-designed drainage plate and an overflow parameter, and obtain the plurality of similarity relationships from the storage module;
determine, based on the to-be-implemented sizing parameter and the plurality of similarity relationships, a design compliance rate for the to-be-implemented sizing parameter;
in response to a determination that the design compliance rate is smaller than a first preset threshold:
run a simulation instruction which is stored in the storage module, the simulation instruction being configured to perform a plurality of iterations, each iteration including at least one simulation, and obtain an average stability of a drainage pattern based on results of a plurality of simulations; wherein each iteration includes:
establishing a simulation model of a to-be-designed overflow system based on the to-be-implemented sizing parameter, wherein the to-be-designed overflow system includes an overflow brick, an overflow groove, a glass liquid feeding device, and a drainage plate; and
performing a simulation on the to-be-designed overflow system for manufacturing glass by the overflow process based on the simulation model, and determining a stability of the drainage pattern for the iteration; and
in response to a determination that the average stability of the drainage pattern is smaller than a second preset threshold:
generate a recommended optimization parameter and generate a reminder message based on the recommended optimization parameter, and send the reminder message to the interaction module.

12. The design system of claim 11, wherein a relational formula for the geometric structure similarity relationship is as follows:
$${H}_{10} = {H}_{10 ref} \times \frac{{H}_{V}}{{H}_{Vref}} ,$$
$${H}_{20} = {H}_{20 ref} \times \frac{{H}_{V}}{{H}_{Vref}} ,$$
$${V}_{10} = {V}_{10 ref} \times \frac{{H}_{V}}{{H}_{Vref}} ,$$
$${V}_{20} = {V}_{20 ref} \times \frac{{H}_{V}}{{H}_{Vref}} ,$$
$${Δ}_{0} = {Δ}_{ref} \times \frac{{H}_{V}}{{H}_{Vref}} ,$$
wherein H₁₀, H₂₀, V₁₀, V₂₀, and Δ₀ are a standard first height, a standard second height, a standard first width, a standard second width, and a standard upper-and-lower contraction width of the to-be-designed drainage plate, respectively, at which time the glass stably flows out of a plate tip of the to-be-designed drainage plate; H_{10ref}, H_{20ref}, V_{10ref}, V_{20ref}, and Δ_{ref} are a standard first height, a standard second height, a standard first width, a standard second width, and a standard upper-and-lower contraction width of the reference drainage plate, respectively, at which time the glass stably flows out of a plate tip of the reference drainage plate; H_{V} is a slope height of a to-be-designed overflow brick; and H_{Vref} is a slope height of a reference overflow brick.

13. The design system of claim 11, wherein a relational formula for the drainage plate width similarity relationship is as follows:
$${W}_{Y} = γ \times ( \frac{{H}_{2}}{{H}_{20}} + \frac{{V}_{1}}{{V}_{10}} - 2 ) \times \{ [ W - 2 \times ( {V}_{20} - {V}_{10} ) ] - {W}_{{J 0}^{}} \} + γ \times [ W - 2 \times ( {V}_{20} - {V}_{10} ) ] ,$$
wherein H₂ and V₁ are an actual second height and an actual first width of the to-be-designed drainage plate, respectively; W is a width of an overflow surface of the to-be-designed overflow system, and γ is the overflow coefficient, γ=0.97113.

14. The design system of claim 11, wherein a relational formula for the critical contraction width similarity relationship is as follows:
$${W}_{J} = ( W - 202.71 \times \frac{{H}_{V}}{{H}_{Vref}} ) + 108.49 \times \frac{{V}_{2}}{{V}_{20}} \times \frac{{H}_{V}}{{H}_{Vref}} ,$$
wherein V₂ is an actual second width of the to-be-designed drainage plate.

15. The design system of claim 11, wherein a relational formula for the critical side plate flow similarity relationship is as follows:
$${Q}_{E 0 J} = {Q}_{E 0} \times [ \frac{{V}_{2}}{{V}_{20}} \times ( 1 - ε ) + ε ] ,$$
wherein Q_{E0} is an uncontracted average side plate flow quality, which is a side plate flow before entering an inclined plane of the overflow brick; ε is the flow contraction ratio of the side plate without the drainage plate, ε=0.95650; and
a formula for determining the uncontracted average side plate flow quality is as follows:
$${Q}_{E 0} = \frac{Q}{2} \times ( 1 - \frac{{W}_{G}}{W} ) ,$$
wherein Q is a design lead-out quality of manufacturing a glass substrate, W_{G} is the standard width of the glass substrate, and W is a width of an overflow surface of the to-be-designed overflow system.

16. The design system of claim 11, wherein a relational formula for the drainage side plate thickness similarity relationship is as follows:
$${T}_{E} = T \times \frac{{W}_{G}}{( {W}_{J} - {W}_{G} ) \times β} \times \frac{2 \times {Q}_{E 0 J}}{Q - 2 \times {Q}_{E 0 J}} ,$$
wherein T is the standard thickness of the glass substrate, and β is an edge drawing factor of the side plate; and
the formula for the edge drawing factor of the side plate is as follows:
$$β = 0.43507 \times \frac{{W}_{G}}{W} \times \sqrt{\frac{T}{0.5}} .$$

17. The design system of claim 11, wherein a relational formula for the average side plate width similarity relationship is as follows:
$${W}_{E} = \frac{1}{2} \times ( {W}_{Y} - 1.04 \times {W}_{G} ) .$$

18. The design system of claim 11, wherein an actual structure size of the to-be-designed drainage plate satisfies:
$$\frac{{H}_{1}}{{H}_{10}} = \frac{{H}_{2}}{{H}_{20}} = \frac{{V}_{1}}{{V}_{10}} = \frac{{V}_{2}}{{V}_{20}} = \frac{Δ}{{Δ}_{0}}$$
wherein H₁, H₂, V₁, V₂ and Δ are, respectively, an actual first height, an actual second height, an actual first width, an actual second width, and an actual upper-and-lower contraction width of the to-be-designed drainage plate, at which time the glass deviates from a plate tip of the to-be-designed drainage plate and flows out, and the greater the deviation, the worse a drainage stability; H₁₀, H₂₀, V₁₀, V₂₀ and Δ₀ are, respectively, a standard first height, a standard second height, a standard first width, a standard second width, and a standard upper-and-lower contraction width of the to-be-designed drainage plate, at which time the glass flows out stably from the plate tip of the reference drainage plate.

19. The design system of claim 11, wherein the first preset threshold and the second preset threshold are related to a regulation sensitivity of a glass substrate manufacturing system on a production line.

20. The design system of claim 11, wherein the design module is further configured to:
determine, based on the to-be-implemented sizing parameter and the plurality of similarity relationships, a plurality of ratios and a plurality of differences; and
determine, based on the plurality of ratios and the plurality of differences, the design compliance rate for the to-be-implemented sizing parameter.

21. The design system according to claim 20, wherein the design module is further configured to:
determine, based on a first height in the to-be-implemented sizing parameter and a standard first height of the to-be-designed drainage plate, a first ratio and a first difference;
determine, based on a second height in the to-be-implemented sizing parameter and a standard second height of the to-be-designed drainage plate, a second ratio and a second difference;
determine, based on a first width in the to-be-implemented sizing parameter and a standard first width of the to-be-designed drainage plate, a third ratio and a third difference;
determine, based on a second width in the to-be-implemented sizing parameter and a standard second width of the to-be-designed drainage plate, a fourth ratio and a fourth difference; and
determine, based on the upper-and-lower contraction width in the to-be-implemented sizing parameter and the standard upper-and-lower contraction width of the to-be-designed drainage plate, a fifth ratio and a fifth difference.

22. The design system of claim 21, wherein the design module is further configured to:
determine an average value of the first ratio, the second ratio, the third ratio, the fourth ratio, and the fifth ratio;
generate a plurality of candidate ratios based on the average value;
for each candidate ratio of the plurality of candidate ratios, generate a set of candidate optimization parameters;
predict, using a prediction model, a predicted stability corresponding to each set of candidate optimization parameters, the prediction model being a machine learning model;
simulate a set of candidate optimization parameters for which the corresponding predicted stability is greater than a third preset threshold, and determine an average stability of a drainage pattern corresponding to the each set of candidate optimization parameters; and
sort average stabilities in a descending order, and determine N sets of candidate optimization parameters corresponding to first N average stabilities as N sets of recommended optimization parameters.

23. The design system of claim 22, wherein the prediction model is obtained by training based on a plurality of first training samples with a first label, and a training process includes:
obtaining the plurality of first training samples with the first label to form a first training sample set, and performing a plurality of iterations based on the first training sample set, wherein at least one iteration includes:
selecting one or more first training samples from the first training sample set, inputting the one or more first training samples into an initial prediction model, and obtaining one or more first prediction outputs corresponding to the one or more first training samples;
determining a value of a predefined first loss function by substituting the first prediction outputs and the first label into a formula for the first loss function; and
iteratively updating model parameters of the initial prediction model according to the value of the first loss function until a first iteration end condition is satisfied, ending the plurality of iterations and obtaining a trained prediction model.

24. The design system of claim 23, wherein different first training samples correspond to different learning rates, and each learning rate for each first training sample is determined based on a design compliance rate corresponding to the first training sample.

25. The design system of claim 22, wherein the third preset threshold is related to a computational performance of the design module, the computational performance being determined based on an available hardware resource of the design module.

26. The design system of claim 11, further comprising a control module, wherein the control module is configured to:
communicate with a glass substrate manufacturing system on a production line to obtain a sizing parameter of an actually used drainage plate in the glass substrate manufacturing system;
determine, based on the sizing parameter of the actually used drainage plate and the plurality of similarity relationships, a design compliance rate for the actually used drainage plate; and
generate a preferred monitoring parameter based on the design compliance rate of the actual used drainage plate and send the preferred monitoring parameter to the glass substrate manufacturing system.

27. The design system of claim 26, wherein the control module is further configured to:
obtain sensing data from the glass substrate manufacturing system during a production of a glass substrate, the sensing data being obtained based on the preferred monitoring parameter, and the sensing data including at least image data;
determine, based on the sensing data, a quality feature of an output glass substrate by a quality assessment model, the quality assessment model being a machine learning model; and
generate, based on the quality feature, a corresponding warning message.

28. The design system of claim 27, wherein the quality assessment model is obtained by training based on a plurality of second training samples with a second label, a training process including:
obtaining the plurality of second training samples with the second label to form a second training sample set, and performing a plurality of iterations based on the second training sample set, wherein at least one iteration includes:
selecting one or more second training samples from the second training sample set, inputting the one or more second training samples into an initial quality assessment model, and obtaining one or more second prediction outputs corresponding to the one or more second training samples;
determining a value of a predefined second loss function by substituting the second prediction outputs and the second label into a formula for the second loss function; and
iteratively updating model parameters of the initial quality assessment model according to the value of the second loss function until a second iteration end condition is satisfied, ending the plurality of iterations and obtaining a trained quality assessment model.

29. The design system of claim 27, wherein an input of the quality assessment model further includes the sizing parameter of the actually used drainage plate and the design compliance rate of the actually used drainage plate.

30. A glass drainage plate manufactured based on a glass substrate using an overflow process, wherein the glass drainage plate is manufactured based on the design system according to claim 11.
